(19) United States
(12) Patent Application Publication
(10) Pub. No.: US 2002/0048385 A1
(43) Pub. Date: Apr. 25, 2002

(54) Personal talking aid for cellular phone

(76) Inventor: Ilan Rosenberg, Naharia (IL)

Correspondence Address: William H. Dippert, Cowan, Liebowitz & Latman, P.C., 1133 Avenue of the Americas, New York, NY, 10036, US

(21) Appl. No.: 09/950,042

(22) Filed: Sep. 10, 2001

Related U.S. Application Data
(60) Provisional application No. 60/231,922, filed on Sep. 11, 2000.

(51) Int. Cl. H04R 25/00

(52) U.S. Cl. 381/374; 381/375; 381/381; 381/382

(57) ABSTRACT

The present invention provides a hearing and talking device for cellular phone through which a user can hear and speak in the cellular phone from a distance. The hearing and talking device comprises a first tube having a first opening and a second opening; the first opening is aerodynamically communicating with a microphone of the cellular phone and the second opening is suspended in the vicinity of the user's mouth. The device further comprises a second tube having a third opening and a fourth opening; the third opening is aerodynamically communicating with a speaker of the cellular phone and the fourth opening is held in the user's external acoustic meatus. Acoustic waves progress from the user's mouth to the microphone and other acoustic waves progress from the speaker to the user's ear without scattering electromagnetic radiation in the vicinity of the user's head.

### FIELD OF THE INVENTION

The present invention is related to talking and hearing aid device for cellular phone. More particularly, the present invention is related to talking and hearing aid that is radiation proof.

The present invention relates to a provisional application Ser. No. 60/231922 submitted to the United States Patent and Trademark Office on Sep. 11, 2000.

### BACKGROUND OF THE INVENTION

The use of cellular phones had spread all over the world in the last decade from the business world to almost all communities. Nowadays, the usage of cellular phones is so popular that even children and housewives are using at least one device. One of the hazards in using a cell phone is in the electromagnetic radiation that is scattered all around the device. The cellular devices are very small and are held near the ear of the user for a relatively long time; hence held in the vicinity of the head. Moreover, the time each user uses his cellular phone becomes longer and longer. Electromagnetic radiation hazards to the brain and to other internal organs in the head had been shown to exist by medical researchers all over the world. Moreover, the hazard was shown to be greater for children, especially in their early years.

There were many attempts to reduce the radiation hazard of cellular phones. In one of the aspects, the cell phone was connected to hearing and talking aid that was electronically connected to the cellular phone. This aid facilitates the user to hear through an earplug and talk to an external microphone so that the cellular phone may be held in a sufficient distance from the user's head. It was assumed that holding the cellular phone distantly from the head of the user would prevent radiation in the vicinity of the brain.

These hearing and talking aids devices are severely criticized. It was even suggested by the academic and medical community that the hearing aid transfers the radiation to the brain even more effectively than the cellular phone itself to the vicinity of the user's brain. Moreover, inserting the electronic device into the outer ear locates the electromagnetic radiation source in an intimate distance with the internal organs of the head.

There is a need to provide an effective and simple, yet cheap hearing and talking aid device that keeps the cellular phone in a sufficient distance from the head of the user so as to prevent electromagnetic radiation from being scattered in the vicinity of the user's brain. The hearing and talking aids have to keep the phone or any other source of radiation in a sufficient distance from the head but at the same time to enable the user to hear very well and to be heard by the user on the other side of the telephone line. The device itself is not provided with components that transfer electromagnetic radiation at all.

### SUMMARY OF THE INVENTION

It is an object of the present invention to provide a new and unique hearing and talking aid device that is connected to a cell phone so that the phone may be held in a distance from the head of the user.

It is another object of the present invention to provide a new and unique hearing and talking aid device that is not provided with electronic components so as to prevent radiation transfer through them.

It is yet another object of the present invention to provide a hearing and talking aid device that retains the voice quality.

It is thus provided a hearing and talking device for cellular phone through which a user can hear and speak in the cellular phone from a distance, said device comprising:

a first impervious tube having a first opening and a second opening, said first opening is aerodynamically communicating with a microphone of the cellular phone and the second opening is suspended in the vicinity of the user's mouth;

a second impervious tube having a third opening and a fourth opening, said third opening is aerodynamically communicating with a speaker of the cellular phone and the fourth opening is held in the user's external acoustic meatus;

whereby acoustic waves progress from the user's mouth to the microphone and other acoustic waves progress from the speaker to the user's ear and electromagnetic radiation in not scattered in the vicinity of the user's head.

Furthermore, in accordance with another preferred embodiment of the present invention, said first impervious tube and said second impervious tube pass through an Y-shaped element that directs each of the tubes to a different direction.

Furthermore, in accordance with another preferred embodiment of the present invention, a portion of said first tube is adjacent to an arm that directs said second opening to the mouth of the user.

Furthermore, in accordance with another preferred embodiment of the present invention, said arm is made of a stiff material.

Furthermore, in accordance with another preferred embodiment of the present invention, an end of said arm is provided with a voice collector, said second opening is clipped in said voice collector.

Furthermore, in accordance with another preferred embodiment of the present invention, a portion of said second impervious tube is adjacent to an arm that directs said fourth opening to the ear of the user.

Furthermore, in accordance with another preferred embodiment of the present invention, said arm is adapted to suspend on an auricle of the user.

Furthermore, in accordance with another preferred embodiment of the present invention, said fourth opening pass through a cushion, said cushion is adapted to be accommodated in the external ear so that said fourth opening is directed towards the user's external acoustic meatus.

Furthermore, in accordance with another preferred embodiment of the present invention, said first impervious tube and said second impervious tube are made from a flexible material.

Furthermore, in accordance with another preferred embodiment of the present invention, a mount is adapted to be mounted onto the cellular phone, said mount is provided with a first pipe having a first aperture aerodynamically communicating with the phone's microphone and a second aperture, and a second pipe having a third aperture aerodynamically communicating with the phone's speaker and a fourth aperture.

Furthermore, in accordance with another preferred embodiment of the present invention, said second aperture is aerodynamically communicating with said first opening and said fourth aperture is aerodynamically communicating with said third opening.

Furthermore, in accordance with another preferred embodiment of the present invention, said second aperture and said fourth aperture are adjacently positioned in said mount.

Additionally, in accordance with another preferred embodiment of the present invention, said first opening and said third opening are connected to a plug, said plug is adapted to aerodynamically communicate with said mount.

### BRIEF DESCRIPTION OF THE FIGURES

FIG. 1a illustrates a user wearing a hearing and talking device in accordance with a preferred embodiment of the present invention.

FIG. 1b illustrates a cellular phone provided with a mount in accordance with a preferred embodiment of the present invention, connected to one side of the hearing and talking device shown in FIG. 1a.

FIG. 2 illustrates a cellular phone, a mount shown from both sides and a hearing and talking device in accordance with a preferred embodiment of the present invention.

FIG. 3 illustrates an enlarged view of the connection between the mount and the hearing and talking device shown in FIG. 2.

### DETAILED DESCRIPTION OF THE INVENTION AND FIGURES

Due to the electromagnetic radiation hazard of cellular phones to the brain and other internal organs in the head of a user, it is required to remove the cell phone from the vicinity of the user's head. The present invention provides a hearing and talking device that is connected to the cell phone from one side while the user, in order to hear or talk through the device, uses the other side so that the phone is in a sufficient distance from the head of the user. The hearing and talking device transfer only acoustic waves but no possible radiation.

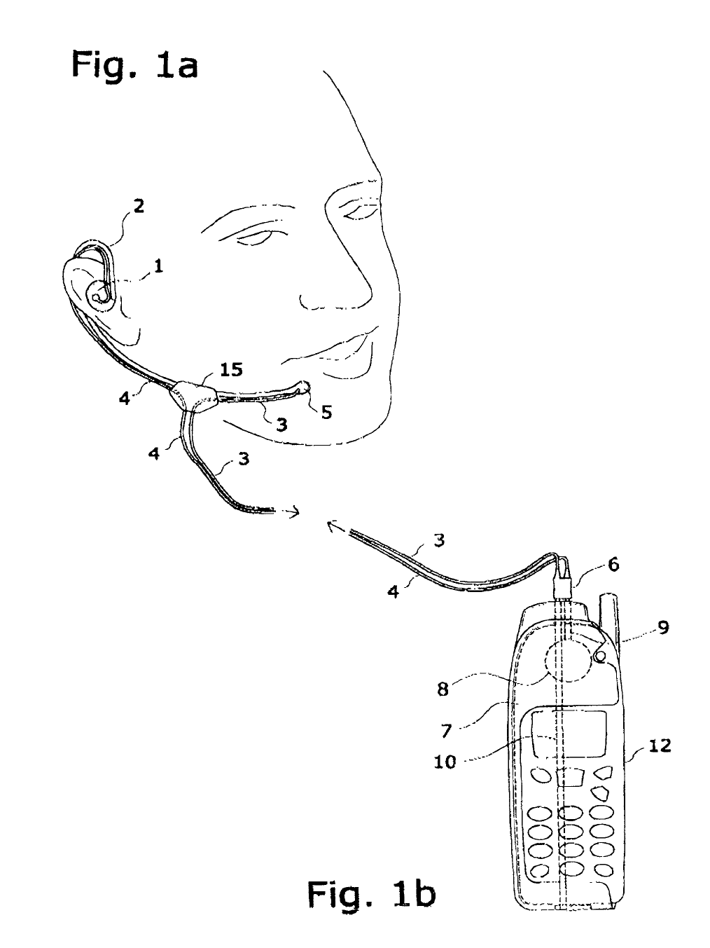

Reference is now made to FIGS. 1a and 1b, illustrating a user wearing a hearing and taking device in accordance with a preferred embodiment of the present invention and a cellular phone provided with a mount in accordance with a preferred embodiment of the present invention, connected to one side of the hearing and talking device, respectively. A preferred embodiment of the hearing and talking device of the present invention comprises two aerated tubes. The tubes are impervious, flexible and are made from a polymeric material. A first tube 3 is adapted to transfer acoustic waves from a mouth of a user to the cell phone and a second tube 4 is adapted to transfer the sound waves from the cell phone to the user's ear. First tube 3 and second tube 4 pass through a splitter 15 that is preferably a Y-shapes element, so that the tubes are held together at one side of splitter 15 and split to two directions at the other side so that each tube is directed to another direction. First tube 3 is directed towards the mouth of the user and second tube 4 is directed towards the user's ear. Each of the split tubes resides adjacently to a corresponding arm. First tube 3 goes along a first arm 5 that is designed to direct the tube to the user's mouth. Second tube 4 goes along a second arm 2 that is designed to direct the tube towards the ear of the user, preferably to the external acoustic meatus. Directing the tubes requires the arms to be from slightly stiff material so as to firmly hold the tubes in place. The length of second arm 2 is such that it may be wrapped on the auricle of the user and suspended on it while first arm 3 reaches the mouth.

The end of first arm 5 is provided with a means to clip first tube 3 so that its opening will be suspended near the mouth of the user. The end of first arm 5 is preferably shaped as a voice collector. At the hearing side, the end of second end 2 is provided with a cushion I that is held inside the outer ear. The end of second tube 4 is clipped in cushion 1 so that the sound waves passing through the tube are exiting directly into the user's ear.

The other side of first tube 3 and second tube 4 are attached to a plug 6 that connects cellular phone 12 with both tubes. A mount 7 is mounted on cellular phone 7 so as to adjust pipes 3 and 4 to reach microphone 20 and speaker 8.

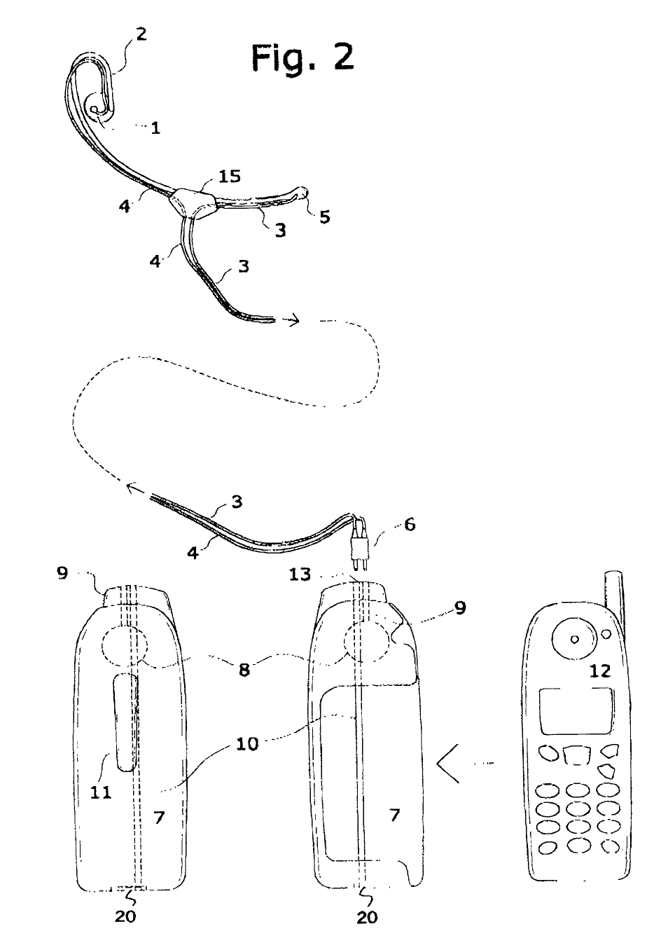

Reference is made to FIG. 2 illustrating a cellular phone, the mount and a hearing and talking device in accordance with a preferred embodiment of the present invention. Cellular phone 12 is a regular and known cell phone. Cellular phone 12 is provided with a mount 7 that is adapted to be mounted on the phone and corresponds the size and shape of the phone. Mount 7 is provided with preferably two air pipes that are adapted to transfer the acoustic waves from first pipe 3 and second pipe 4 to the vicinity of a microphone and a speaker of the cellular phone, respectively. Air pipe 10 is extended from the top of mount 7 to microphone connector 20 and air pipe 9 is extended to reach speaker connector 8.

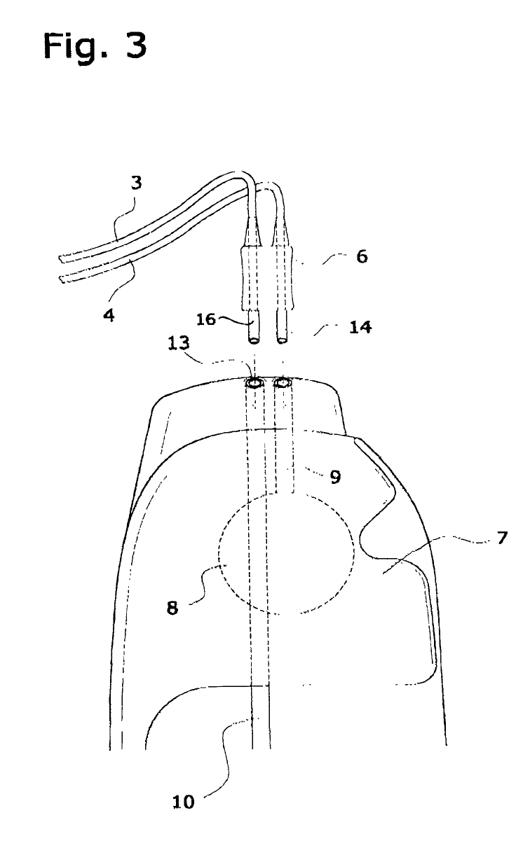

Reference is now made to FIG. 3 illustrating an enlarged view of the connection between the mount and the hearing and talking device shown in FIG. 2. First pipe 3 passes through plug 6 and protrudes from the other side of the plug with a rigid transmitter 16. Second pipe 4 passes as well through plug 6 and protrudes with another rigid transmitter 14. Both transmitters, 14 and 16, are adapted to be inserted into corresponding sockets 13 that are provided on top of mount 7. The transmitters are rigid enough so they can be easily inserted into sockets 13 without being folded or bent. The socket through which transmitter 14 is inserted, is extended through air pipe 9 to speaker connector 8 so that acoustic waves may be transmitted from the speaker through air pipe 9, then through transmitter 14 and through second tube 4 to reach the user's ear. It is important to notice that the speaker of the cellular phone is impervious to the outer surrounding and the sound waves that emerges from the speaker are collected in speaker connector 8 of mount 7 and are transferred to the air pipe. There are no disturbances to the acoustic waves along this path.

Air pipe 10 extends from the microphone connector (can not be seen in FIG. 3), through transmitter 16 and then through first tube 3 to the user's mouth. Again, there are no disturbances to the acoustic waves when they progress through the pipes and tubes in the path from the microphone to the mouth of the user and the microphone is aerodynamically communicating with the microphone connector of the mount so that the sound waves that progresses from the user's mouth to the microphone are transferred only to the microphone and cannot escape to the outer environment.

When the user talks in the vicinity of an open end of first tube 3, his voice progresses through the tubes to the microphone and when voice is sounded from the speaker, its acoustic waves progresses towards the ear of the user so that he may hear the sounds through an open end of the tube. The tubes themselves may be of any significant length and are made of a flexible material so that the cellular phone may be held in a sufficient distant from the head of the user. This will prevent electromagnetic radiation from being scattered in the vicinity of the user's brain and other internal organs in his head. Users may use cellular phones for as much time as they need without being anxious about the electromagnetic hazard.

It should be clear that the description of the embodiments and attached Figures set forth in this specification serves only for a better understanding of the invention, without limiting its scope as covered by the following claims.

It should also be clear that a person in the art, after reading the present specification could make adjustments or amendments to the attached Figures and above described embodiments that would still be covered by the following claims.

1. A hearing and talking aid device for cellular phone through which a user can hear and speak in the cellular phone from a distance, said device comprising:
a first impervious tube having a first opening and a second opening, said first opening is aerodynamically communicating with a microphone of the cellular phone and the second opening is suspended in the vicinity of the user's mouth;
a second impervious tube having a third opening and a fourth opening, said third opening is aerodynamically communicating with a speaker of the cellular phone and the fourth opening is held in the user's external acoustic meatus;
whereby acoustic waves progress from the user's mouth to the microphone and other acoustic waves progress from the speaker to the user's ear and electromagnetic radiation is not scattered in the vicinity of the user's head.

2. The device as claimed in claim 1, wherein said first impervious tube and said second impervious tube pass through an Y-shaped element that directs each of the tubes to a different direction.

3. The device as claimed in claim 1, wherein a portion of said first impervious tube is adjacent to an arm that directs said second opening to the mouth of the user.

4. The device as claimed in claim 3, wherein said arm is made of a stiff material.

5. The device as claimed in claim 3, wherein an end of said arm is provided with a voice collector, said second opening is clipped in said voice collector.

6. The device as claimed in claim 1, wherein a portion of said second impervious tube is adjacent to an arm that directs said fourth opening to the ear of the user.

7. The device as claimed in claim 6, wherein said arm is adapted to suspend on an auricle of the user.

8. The device as claimed in claim 1, wherein said fourth opening pass through a cushion, said cushion is adapted to be accommodated in the external ear so that said fourth opening is directed towards the user's external acoustic meatus.

9. The device as claimed in claim 1, wherein said first impervious tube and said second impervious tube are made from a flexible material.

10. The device as claimed in claim 1, wherein a mount is adapted to be mounted onto the cellular phone, said mount is provided with a first pipe having a first aperture aerodynamically communicating with the phone's microphone and a second aperture, and a second pipe having a third aperture aerodynamically communicating with the phone's speaker and a fourth aperture.

11. The device as claimed in claim 10, wherein said second aperture is aerodynamically communicating with said first opening and said fourth aperture is aerodynamically communicating with said third opening.

12. The device as claimed in claim 10, wherein said second aperture and said fourth aperture are adjacently positioned in said mount.

13. The device as claimed in claim 10, wherein said first opening and said third opening are connected to a plug, said plug is adapted to aerodynamically communicate with said mount.
